(19) United States
(12) Patent Application Publication
(10) Pub. No.: US 2019/0023093 A1
(43) Pub. Date: Jan. 24, 2019

(54) MOTOR VEHICLE WITH AN INDEPENDENT SUSPENSION

(71) Applicant: FORD GLOBAL TECHNOLOGIES, LLC, Dearborn, MI (US)

(72) Inventors: Thomas GERHARDS, Niederzier (DE); Ralf HINTZEN, Aachen (DE); Daniel MAINZ, Herzogenrath (DE); Rainer SOUSCHEK, Aachen (DE); Paul ZANDBERGEN, Wuerselen (DE); Friedrich Peter WOLF-MONHEIM, Aachen (DE)

(73) Assignee: FORD GLOBAL TECHNOLOGIES, LLC, Dearborn, MI (US)

(21) Appl. No.: 16/032,257

(22) Filed: Jul. 11, 2018

(30) Foreign Application Priority Data
Jul. 24, 2017 (DE) 10 2017 212 638.8

(51) Int. Cl. B60G 3/20; B60G 3/28; B60G 7/00

(52) U.S. Cl. CPC B60G 3/20; B60G 3/28; B60G 7/001; B60G 2204/143; B60G 2200/182; B60G 2300/50; B60G 7/008

(57) ABSTRACT

The disclosure relates to a motor vehicle, in particular an electric vehicle or a hybrid electric vehicle. The motor vehicle has a longitudinal link rear axle with independent suspensions. Each independent suspension has a wheel carrier, a longitudinal link rigidly connected to the wheel carrier, articulated to a vehicle body of the motor vehicle, and three lateral links connected firstly to the wheel carrier and secondly to the vehicle body, or to an auxiliary frame connected to the vehicle body. A wheel axle oriented in a lateral direction of the vehicle runs through the wheel carrier. To create additional installation space for an arrangement of a traction battery of the motor vehicle, the lateral links are arranged completely offset from the wheel axle at the rear end in relation to a longitudinal axis of the vehicle of the motor vehicle.

### CROSS-REFERENCE TO RELATED APPLICATIONS

This application claims foreign priority benefits under 35 U.S.C. § 119(a)-(d) to DE Application 10 2017 212 638.8 filed Jul. 24, 2017, which is hereby incorporated by reference in its entirety.

### TECHNICAL FIELD

The disclosure relates to a motor vehicle, in particular an electric vehicle or a hybrid electric vehicle, having a longitudinal link rear axle with independent suspensions.

### BACKGROUND

A motor vehicle may be fitted with a rear axle in a form of a longitudinal link, rear axle, which has an independent suspension for each rear wheel. Each independent suspension comprises a wheel carrier on which a respective rear wheel is mounted rotatably via a wheel bearing. In addition, each independent suspension comprises a longitudinal link connected to the respective wheel carrier, also referred to as a sword longitudinal link, that, at a front end, forward of the wheel carrier is articulated pivotably about a horizontal pivot axis to a vehicle body of the motor vehicle axle. Furthermore, each independent suspension comprises a lateral link in a form of a lower lateral link that is arranged, geodetically, lower or on a floor side below a wheel axle oriented in a lateral direction of the vehicle running through the wheel carrier, a lateral link in a form of a camber link and a lateral link in a form of a toe link. Each lateral link is articulated firstly to a respective wheel carrier and secondly to a vehicle body or to an auxiliary frame connected to the vehicle body.

In order to cushion the vehicle body, a spring is arranged on each independent suspension, which can be supported firstly on the vehicle body and secondly on a spring plate connected at least indirectly to the wheel carrier in each case. In addition, at least one vibration damper—also referred to as a shock absorber—can be arranged on each independent suspension, through which vibrations of the vehicle body in relation to the respective wheel carrier can be damped. The vibration damper can be supported firstly on the vehicle body and secondly at least indirectly on the respective wheel carrier.

In principle, an upper lateral link that is arranged geodetically higher than a wheel axle running through the wheel carrier and a lower lateral link that is arranged geodetically lower than the wheel axle may be a same length, as a result of which, however, during compression, a track width of the rear axle changes and a rear wheel in each case follows a lateral inclination of the vehicle body in each case. In order to prevent this, the upper lateral link may be shorter than the lower lateral link, so that during spring compression, a negative camber results that, for example, counteracts a rolling motion of the vehicle body when cornering. Due to this use of a short and a long lateral link, this embodiment of an independent suspension is also referred to as an SLA (short and long arm) wheel suspension.

U.S. Pat. No. 6,945,547 B2 relates to a multi-link suspension assembly for a vehicle wheel that comprises a wheel carrier, an upper lateral link, a lower lateral link, a toe link and a longitudinal link. The wheel carrier is oriented along a longitudinal axis of a vehicle. The upper lateral link and the lower lateral link are oriented near a wheel center along a lateral axis of the vehicle and pivotably connected to the wheel carrier. The toe link is oriented behind the wheel center along a lateral axis of the vehicle and is pivotably connected to the wheel carrier. The longitudinal link is oriented along the longitudinal axis of the vehicle body and is pivotably connected to the wheel carrier forward of the wheel center and also pivotably connected to the lower lateral link near the wheel center.

US 2007/0007742 A1 and U.S. Pat. No. 7,325,820 B2 each disclose a rear suspension system for a vehicle having a body, at least two full frame rails, and at least one cross member secured to the two frame rails. The suspension comprises a wheel support including a knuckle aligned with a mathematical axis; a trailing arm that extends from a point on the frame rail forward of the mathematical axis to a wheel support knuckle; an upper connecting link that extends from a point on the frame rail via the mathematical axis, to the wheel support knuckle; a toe connecting link that is fastened to the frame rail below the mathematical axis and extends between the frame rail and the trailing arm; a lower control arm that extends from one of the cross members to the knuckle, wherein the lower control arm is fastened to the cross member within the frame rail, near the wheel support knuckle to the wheel support knuckle, wherein the lower control arm is more than twice as long as the toe link, in order to allow a shock ratio of less than or equal to 1.3:1; a shock absorber that is secured to the lower control arm and the frame; and a spring secured to the shock absorber and the frame.

DE 10 2013 210 338 A1 relates to a multi-link rear axle for a vehicle comprising, on both sides of the vehicle, a wheel suspension that has, in each case, at least a lower lateral link, an upper lateral link and a sword link, wherein the lateral link and the sword link are each arranged with one of their ends on a wheel carrier, wherein a leaf spring is provided arranged laterally to a direction of travel of the vehicle between the wheel suspensions, which leaf spring is arranged to extend below the upper lateral link and be connected to the wheel carrier at the end via at least one link element in each case.

U.S. Pat. No. 9,579,942 B2 relates to an independent rear suspension system of a vehicle having a wheel carrier provided for rotatable mounting of a road wheel, which is designed to be attached via individual links to an auxiliary frame or structure of the vehicle. The links comprise a lower carrying link, as well as a camber link and a toe link. The carrying link has a single connection portion on a road wheel side, via which the wheel carrier is only coupled directly in an articulated manner with the carrying link.

U.S. Pat. No. 7,891,684 B1 relates to an uncoupled five-link independent rear suspension system that is arranged on a rear wheel corner adjacent to a body carrier of a motor vehicle comprising: a wheel carrier; a camber link that is connected to the wheel carrier; a toe link that is connected to the wheel carrier; a spring link that is connected to the wheel carrier; a lower longitudinal link that is connected to the wheel carrier; and an upper longitudinal link that is connected to the wheel carrier; wherein the lower and upper longitudinal links are arranged substantially in a longitudinal direction in relation to the motor vehicle and on an outside in relation to an adjacent body carrier, so that the adjacent body carrier is free from a movement enveloping curve of the lower and the upper longitudinal link while the motor vehicle is running.

JP 2017 019 458 A relates to a rear body design for a vehicle in which a battery pack is to be kept in a state in which it can be protected from a load acting on the vehicle at a rear end, without this requiring a rear underbody space. The battery pack is charged on upper parts of a pair of rear side elements. A front end of an auxiliary frame faces a lateral suspension element of a multi-link axis at the rear end, on which a suspension arm with an intermediate space is mounted therebetween. A load acting on the vehicle at the rear end is transmitted from the auxiliary frame onto the rear lateral suspension member and is distributed by the rear side element towards the front via the multi-link axle.

EP 0 899 133 B1 relates to an independent suspension for a rear wheel of a motor vehicle having a longitudinal link, at least one lower front lateral link and one lower rear lateral link. The rear wheel is mounted on a wheel carrier connected directly or indirectly to the vehicle body via the longitudinal link and the lateral link. The longitudinal link and the lower rear lateral link are each connected to the wheel carrier via a bearing arranged behind a wheel axle in a direction of travel. The lower front lateral link is connected to the wheel carrier via a mounting arranged forward of the wheel axle. The mounting of the longitudinal link and of the lower front lateral link on the wheel carrier is arranged substantially at a same height and the longitudinal link has a recess through which the lower front lateral link is guided.

U.S. Pat. No. 7,431,315 B2 relates to a suspension system for a vehicle having a frame and wheels upon which the vehicle is suspended relative to the frame. The suspension system comprises: a wheel carrier to which the wheels of the vehicle are attached, a lower link bushing and an upper link bushing that are attached to the carrier; an upper control arm that is connected to the upper link bushing, a lower control that is connected to the lower link bushing, wherein the upper control arm and the lower control arm are connected to the frame and extend in a generally lateral direction between the carrier and the frame; a longitudinal link that extends in a generally longitudinal direction from a location on the frame forward of the carrier to the carrier, wherein the longitudinal link has a bendable blade member that is fastened to the carrier, wherein the blade element forms at least in part a clevis mount; and a toe link secured between the frame and the clevis mount.

### SUMMARY

The problem addressed by the disclosure is that of creating additional installation space for an arrangement of a traction battery of a motor vehicle.

The problem is solved according to the disclosure by a motor vehicle having lateral links arranged completely offset from a wheel axle at a rear end in relation to a longitudinal axis of the motor vehicle.

It should be pointed out that the features and measures individually listed in the following description can be combined with one another in any technically meaningful manner and disclose further embodiments of the disclosure. The description characterizes and specifies the disclosure, particularly also in connection with the Figures.

According to the disclosure, the lateral links of each independent suspension with respect to the longitudinal axis of the vehicle are arranged completely offset at the rear end of the vehicle from the wheel axle running through a wheel carrier and oriented in a lateral direction of the vehicle. This means that installation space traditionally occupied by lateral links is freed up between the wheel carriers. A portion of a traction battery and/or of a power electronics unit of the motor vehicle can be arranged in the installation space that has been freed up. Consequently, additional installation space for the arrangement of the traction battery and/or for an arrangement of further power electronics components of the motor vehicle is created. In this way, larger traction batteries can be installed, for example, that can increase a driving range of the motor vehicle. A longitudinal link rear axle therefore has a more compact design according to the disclosure than a traditional longitudinal link rear axle. The wheel axle refers to an axle about which rear wheels arranged on the longitudinal link rear axle can turn, so that they can run or roll on a surface that has been driven.

The motor vehicle may, in particular, be an electric vehicle or a hybrid electric vehicle or a plug-in hybrid electric vehicle that has at least one traction battery installed on a floor side that supplies electric drive units of the motor vehicle. The traction battery is preferably arranged in part in the installation space freed up by the disclosure between the wheel carriers.

The longitudinal link of each independent suspension may be connected to the respective wheel carrier via a mechanical connection and/or in a substance-bonded manner. Alternatively, the longitudinal link may be produced integrally with the wheel carrier. The longitudinal link is articulated at its front end to the vehicle body of the motor vehicle and, in this case, the longitudinal link is connected to the vehicle body pivotably about a horizontal pivot axis. For this purpose, a bearing eye may be formed at the front end of the longitudinal link, in which a damping element is arranged, in particular a rubber sleeve, through which a bearing bolt connected to the vehicle body is guided. For this purpose, transmission of vibrations from the longitudinal link to the vehicle body is reduced, in order to reduce vehicle noises in a passenger interior of the motor vehicle. In addition, articulation of the longitudinal carrier to the vehicle body receives more degrees of freedom.

Of three lateral links, one lateral link is preferably a lower lateral link arranged geodetically lower than the wheel axle, another lateral link is a camber link and a further lateral link is a toe link. The camber link is preferably shorter than the lower lateral link and the toe link, as a result of which the longitudinal link rear axle is designed as an SLA longitudinal link rear axle. Each lateral link can be connected via a universal joint to the wheel carrier and via a further universal joint to the vehicle body or to an auxiliary frame connected to the vehicle body. A damping element that dampens transmission of vibrations may be arranged on each universal joint. The auxiliary frame is preferably indirectly connected via damping elements to the vehicle body, in order to reduce transmission of vibrations from the auxiliary frame to the vehicle body.

According to an advantageous embodiment, an articulation point at which a respective lateral link is articulated to the vehicle body, or to the auxiliary frame, is arranged at the rear end, offset from an articulation point with respect to the longitudinal axis of the vehicle, at which articulation point this lateral link is articulated to the wheel carrier. This means that each lateral link runs perpendicularly to a longitudinal axis of the vehicle, and to a lateral axis of the vehicle. In this way, even more installation space is freed up for the arrangement of the traction battery and/or further power electronics components. If the lateral links are articulated to an auxiliary frame connected to the vehicle body, this is arranged at the rear end, offset from the wheel axle in relation to the longitudinal axis of the vehicle.

A further advantageous embodiment envisages that at least one spring is arranged on each independent suspension, which spring is supported firstly on a lower lateral link of the lateral links and secondly on the vehicle body or the auxiliary frame. The lower lateral link is arranged geodetically lower than the wheel axle. The spring is configured as a helical spring and may be combined with a vibration damper. The spring may be produced from a metallic material or a composite material.

According to a further advantageous embodiment, the motor vehicle comprises at least one lateral leaf spring running in the lateral direction of the vehicle, which is secured in a middle region to the vehicle body, or to the auxiliary frame, and is connected at each end, directly or indirectly, to the respective wheel carrier, the respective longitudinal link or one of the respective lateral links. By using a lateral leaf spring rather than springs to cushion the vehicle body, the longitudinal link rear axle may have a more compact design. The lateral leaf spring is preferably secured at two positions on the vehicle body, or auxiliary frame, that are symmetrical to a longitudinal center axis of the vehicle. The lateral leaf spring may be made of a metallic material or a composite fiber material.

According to a further advantageous embodiment, the lateral leaf spring is connected at each end, indirectly via at least one coupling member to the respective wheel carrier, to the respective longitudinal link or one of the respective lateral links. In this way, there is greater design freedom when it comes to an arrangement of the lateral leaf spring. The coupling element may be connected in an articulated manner to the lateral leaf spring, on the one hand, and the respective wheel carrier, the respective longitudinal link or the respective lateral link, on the other hand, and extend vertically.

According to a further advantageous embodiment, the motor vehicle comprises at least one traction battery that is partially arranged between the wheel carriers. The traction battery comprises a plurality of battery cells that may be designed as lithium-ion battery cells, for example.

### BRIEF DESCRIPTION OF THE DRAWINGS

FIG. 1 shows a schematic, bottom view of an exemplary embodiment for a motor vehicle according to the disclosure; and

FIG. 2 shows a schematic, bottom view of a further exemplary embodiment for a motor vehicle according to the disclosure.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

In the different Figures, identical parts are always provided with the same reference numbers, and only described once.

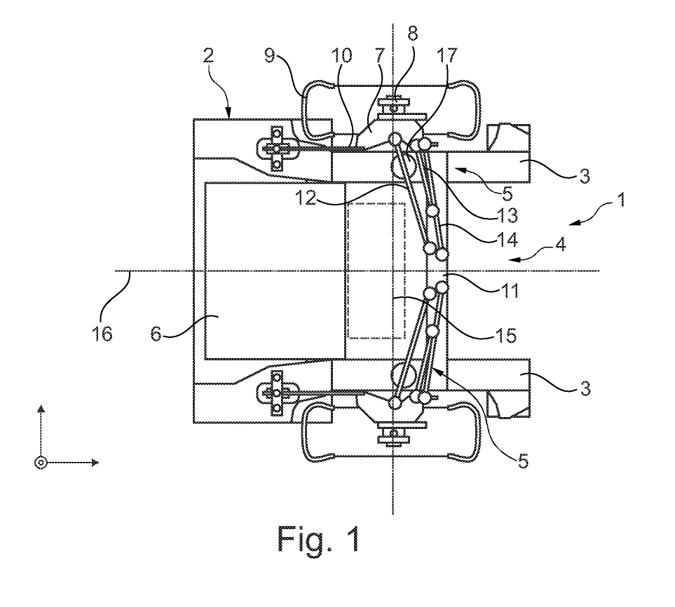

FIG. 1 shows a schematic, bottom view of an exemplary embodiment for a motor vehicle 1 according to the disclosure in the form of an electric vehicle or hybrid electric vehicle. Only a rear portion of the motor vehicle 1 is depicted.

The motor vehicle 1 has a vehicle body 2 with lateral longitudinal supports 3. Furthermore, the motor vehicle 1 has a longitudinal-link rear axle 4 with independent suspensions 5 and a traction battery 6.

Each independent suspension 5 has a wheel carrier 7 on which a wheel bearing 8 is arranged, via which a rear wheel 9 is rotatably arranged on the wheel carrier 7. Furthermore, each independent suspension 5 has a longitudinal link 10 rigidly connected to the wheel carrier 7 articulated to the vehicle body 2 of the motor vehicle 1, which is produced integrally with the wheel carrier 7. In addition, each independent suspension 5 has three lateral links 12, 13 and 14 articulated, firstly, to the wheel carrier 7 and, secondly, to an auxiliary frame 11 connected to the vehicle body 2, wherein lateral link 12 is a lower lateral link 12, lateral link 13 is a camber link 13 and lateral link 14 is a toe link 14. A wheel axle 15, oriented in a lateral direction of the vehicle 1, runs through the wheel carrier 7 of the longitudinal link rear axle 4.

The lateral links 12, 13 and 14 are arranged completely offset from the wheel axle 15 at the rear end with regard to a longitudinal axis 16 of the vehicle 1. In this case, an articulation point at which the respective lateral link 12, 13 or 14 is articulated to the auxiliary frame 11 is arranged at the rear end, offset from an articulation point with respect to the longitudinal axis 16 of the vehicle 1, at which articulation point the lateral links 12, 13 or 14 are articulated to the respective wheel carrier 7, as shown in FIG. 1. The articulation point of the lateral links 12, 13 and 14 to the respective wheel carrier 7 is, likewise, offset from the wheel axle 15 at the rear end, as can likewise be recognized. The traction battery 6 is partially arranged between the wheel carriers 7.

On each independent suspension 5 is arranged a spring 17 that is supported, firstly, on the lower lateral link 12 of the lateral links 12, 13 and 14 and, secondly, on the vehicle body 2.

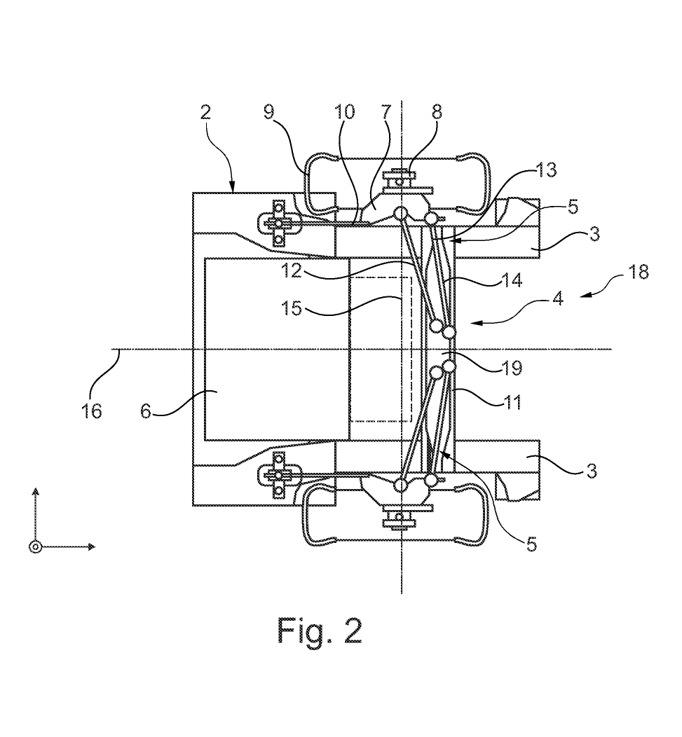

FIG. 2 shows a schematic, bottom view of a further exemplary embodiment for a motor vehicle 18 according to the disclosure being an electric vehicle or hybrid electric vehicle. Only a rear portion of the motor vehicle 18 is depicted.

The motor vehicle 18 differs from the exemplary embodiment shown in FIG. 1 only in that there are no springs present, and, instead of springs, the motor vehicle 18 has a lateral leaf spring 19 running in a lateral direction of the vehicle 18, which lateral leaf spring 19 is secured to the auxiliary frame 11 in a middle region and is connected at each end, directly or indirectly, to the respective wheel carrier 7, the respective longitudinal link 10 or one of the respective lateral links 12, 13 and 14. In this case, the lateral leaf spring 19 may be indirectly connected at each end via at least one coupling element to the respective wheel carrier 7, the respective longitudinal link 10 or one of the respective lateral links 12, 13 and 14. The lateral leaf spring 19 has tapered end portions. The lateral links 12 and 14 are arranged at a floor side of the lateral leaf spring 19, while the lateral link 13 runs above the lateral leaf spring 19.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. An electric vehicle comprising:
a longitudinal link rear axle with independent suspensions, wherein each independent suspension has a wheel carrier, a longitudinal link rigidly connected to the wheel carrier and articulated to a vehicle body, and three lateral links connected to the wheel carrier and the vehicle body; and
a wheel axle, oriented in a lateral direction of the vehicle body, runs through the wheel carrier, wherein the lateral links are arranged completely offset from the wheel axle at a rear end in relation to a longitudinal axis of the vehicle body.

2. The electric vehicle as claimed in claim 1 further comprising an articulation point at which a respective lateral link of the three lateral links, articulated to the vehicle body, is arranged at the rear end offset from the articulation point with respect to the longitudinal axis, at which articulation point the respective lateral link is articulated to the wheel carrier.

3. The electric vehicle as claimed in claim 1 further comprising at least one spring arranged on each independent suspension, wherein the at least one spring is supported on a lower lateral link of the three lateral links and on the vehicle body.

4. The electric vehicle as claimed in claim 1 further comprising at least one lateral leaf spring running in the lateral direction of the vehicle, secured in a middle region of the vehicle body and connected at each end, directly or indirectly, to the wheel carrier and to a respective longitudinal link or one of the three lateral links.

5. The electric vehicle as claimed in claim 4, wherein the at least one lateral leaf spring is connected at each end indirectly via at least one coupling member to the wheel carrier, to the respective longitudinal link or to one of the three lateral links.

6. The electric vehicle as claimed in claim 1 further comprising at least one traction battery partially arranged between the wheel carriers.

7. A rear axle comprising:
independent suspensions, each having a wheel carrier, a longitudinal link rigidly connected to the wheel carrier and articulated to a vehicle body, and three lateral links connected to the wheel carrier and the vehicle body; and
a wheel axle that runs through the wheel carrier, wherein the three lateral links are arranged completely offset from the wheel axle at a rear end, related to a longitudinal axis of the vehicle body.

8. The rear axle as claimed in claim 7 further comprising an articulation point at which a respective lateral link of the three lateral links, articulated to the vehicle body, is arranged at the rear end offset from the articulation point with respect to the longitudinal axis, wherein, at the articulation point, the respective lateral link is articulated to the wheel carrier.

9. The rear axle as claimed in claim 7 further comprising at least one spring arranged on each independent suspension, wherein the at least one spring is supported on a lower lateral link of the three lateral links and on the vehicle body.

10. The rear axle as claimed in claim 7 further comprising at least one lateral leaf spring running in a lateral direction, secured in a middle region of the vehicle body and connected at each end, directly or indirectly, to the wheel carrier and to a respective longitudinal link or one of the three lateral links.

11. The rear axle as claimed in claim 10, wherein the at least one lateral leaf spring is connected at each end indirectly via at least one coupling member to the wheel carrier, to the respective longitudinal link or to one of the three lateral links.

12. The rear axle as claimed in claim 7 further comprising at least one traction battery partially arranged between the wheel carriers.

13. A vehicle comprising:
a longitudinal link rear axle with independent suspensions, each having a wheel carrier, a longitudinal link rigidly connected to the wheel carrier and articulated to a body, and lateral links connected to the wheel carrier and the body; and
a wheel axle, oriented in a body lateral direction, that runs through the wheel carrier, wherein the lateral links are arranged offset, relative to a longitudinal axis, from the wheel axle.

14. The vehicle as claimed in claim 13 further comprising an articulation point at which a respective lateral link of the lateral links, articulated to the vehicle body, is arranged at a rear end offset from the articulation point relative to the longitudinal axis, wherein, at the articulation point, the respective lateral link is articulated to the wheel carrier.

15. The vehicle as claimed in claim 13 further comprising a spring arranged on the independent suspensions, wherein the spring is supported on a lower lateral link of the lateral links and the body.

16. The vehicle as claimed in claim 13 further comprising a leaf spring running in a lateral direction, secured in a middle region of the body being connected at each end, directly or indirectly, to the wheel carrier, the longitudinal link or one of the lateral links.

17. The vehicle as claimed in claim 16, wherein the leaf spring is connected at each end, indirectly via a coupling member, to the wheel carrier, the longitudinal link or one of the lateral links.

18. The vehicle as claimed in claim 13 further comprising a traction battery partially arranged between the wheel carriers.
